(19) United States
(12) Patent Application Publication
(10) Pub. No.: US 2026/0160542 A1
(43) Pub. Date: Jun. 11, 2026

(54) ALIGNMENT PLATFORM AND CALIBRATION METHOD

(71) Applicants: Chin-Hsing Chuo, Taichung City (TW); Chin-Yen Wang, Taichung City (TW)

(72) Inventors: Chin-Hsing Chuo, Taichung City (TW); Chin-Yen Wang, Taichung City (TW)

(21) Appl. No.: 19/412,200

(22) Filed: Dec. 8, 2025

(30) Foreign Application Priority Data
Dec. 11, 2024 (TW) 113148105

(51) Int. Cl. G01B 11/27; G01D 11/02; G01D 18/00

(52) U.S. Cl. CPC G01B 11/27; G01D 11/02; G01D 18/00; G01D 2218/10

(57) ABSTRACT

An alignment platform is provided, wherein the alignment platform includes: a base; a platform member movably disposed on the base; a drive device configured to drive the platform member to move relative to the base; at least one air passageway, the at least one air passageway being disposed in one of the base and the platform member to eject air so as to support the platform member above the base in a non-contact manner; and an optical measuring device including an optical scale and a read head, one of the optical scale and the read head being disposed on the platform member and the other being disposed on the base, the optical scale and the read head corresponding to each other. A calibration method carried out with the alignment platform is further provided.

### BACKGROUND OF THE INVENTION

### Field of the Invention

The present invention relates to an alignment device, particularly to an alignment platform and calibration method.

### Description of the Prior Art

In a conventional alignment platform, such as that disclosed in TW M429543, an alignment platform includes a base, a platform, and a carrier which is disposed on the base and carries the platform. A rotation mechanism of the carrier includes a connecting portion and a bearing. When the platform is displaced or rotated, the connecting portion and the bearing are driven to rotate. In the conventional technology, rotation of the platform relative to the base is achieved through the bearing. However, when rotation of the platform relative to the base is achieved by means of the bearing, there are drawbacks in that frictional resistance during rotation of the platform relative to the base is large, a relatively large driving force is required, the platform tends to wobble during rotation, and accuracy of alignment calibration is low.

The present invention is, therefore, arisen to obviate or at least mitigate the above-mentioned disadvantages.

### SUMMARY OF THE INVENTION

The main object of the present invention is to provide an alignment platform and calibration method which are configured to allow a platform to be suspended above a base to move, and which further provide optical measuring calibration with high calibration accuracy.

To achieve the above and other objects, an alignment platform is provided, wherein the alignment platform includes: a base; a platform member movably disposed on the base; a drive device configured to drive the platform member to move relative to the base; at least one air passageway, the at least one air passageway being disposed in one of the base and the platform member to eject air so as to support the platform member above the base in a non-contact manner; and an optical measuring device including an optical scale and a read head, one of the optical scale and the read head being disposed on the platform member, the other of the optical scale and the read head being disposed on the base, the optical scale and the read head corresponding to each other.

To achieve the above and other objects, a calibration method carried out with the alignment platform is provided, wherein the calibration method includes steps of: positioning the platform member by each of the at least one air passageway sucking the platform member to be on the base; shooting a workpiece placed on the platform member to obtain an imaging result; supporting the platform member above the base in a non-contact manner by ejection of air from each of the at least one air passageway; carrying out an alignment correction by driving the platform member to rotate relative to the base to perform position correction according to the imaging result and a measuring result of the optical measuring device; and positioning the platform member by each of the at least one air passageway sucking the platform member to be on the base, and shooting the workpiece placed on the platform member again.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is an exploded view of the first exemplary embodiment of the present invention;

FIG. 3 is another exploded view of the first exemplary embodiment of the present invention;

FIG. 4 is a cross-sectional view of the first exemplary embodiment of the present invention;

FIG. 5 is a partially enlarged view of FIG. 4;

FIG. 6 is a schematic view illustrating a suspended platform being calibrated in the first exemplary embodiment of the present invention;

FIG. 7 is a partially enlarged view of FIG. 6;

FIG. 8 is another cross-sectional view of the first exemplary embodiment of the present invention;

FIG. 9 is still another cross-sectional view of the first exemplary embodiment of the present invention;

FIG. 10 is a perspective view of a second exemplary embodiment of the present invention;

FIG. 11 is an exploded view of the second exemplary embodiment of the present invention;

FIG. 12 is another exploded view of the second exemplary embodiment of the present invention;

FIG. 13 is a cross-sectional view of the second exemplary embodiment of the present invention; and

FIG. 14 is a flow chart of a calibration method of the first exemplary embodiment of the present invention.

### DETAILED DESCRIPTION OF THE PREFERRED EMBODIMENTS

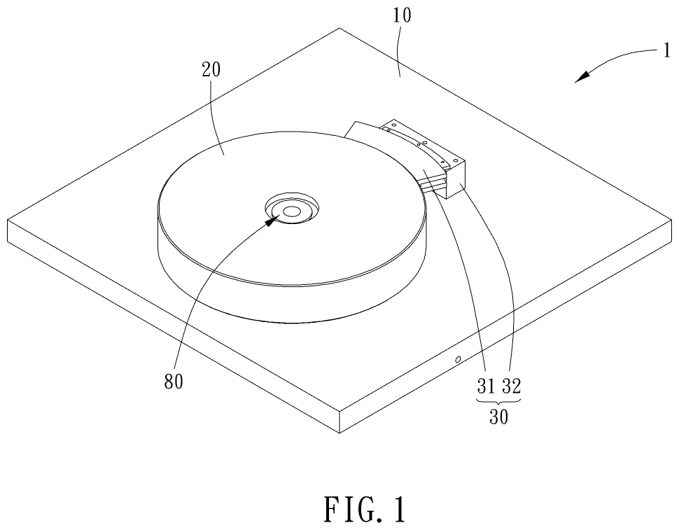

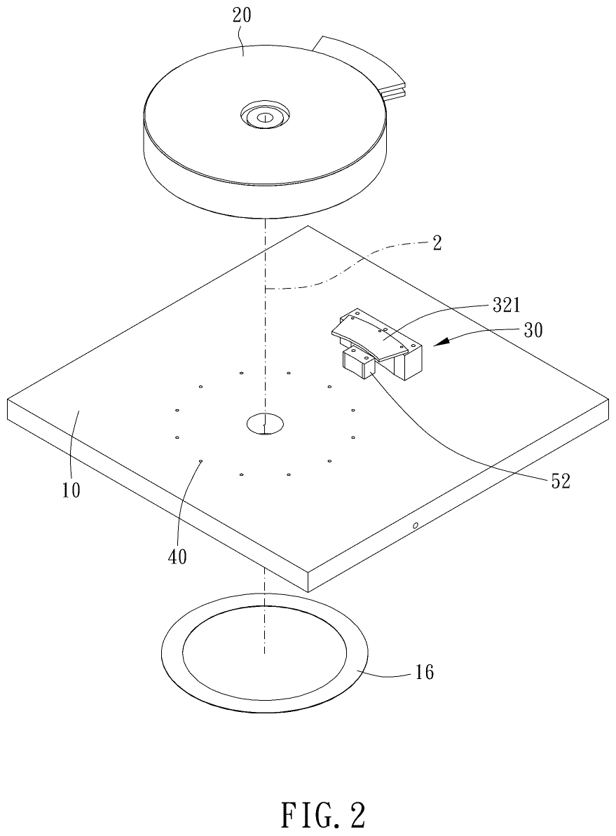

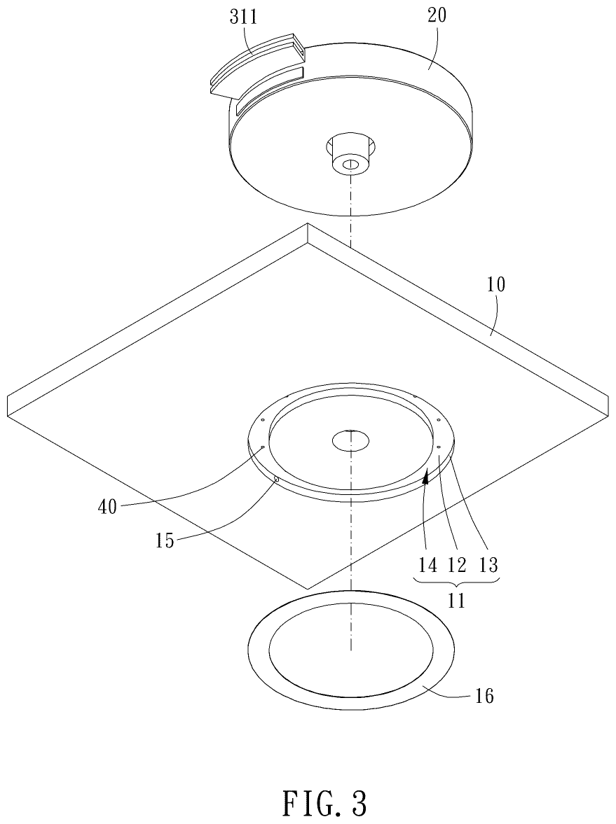

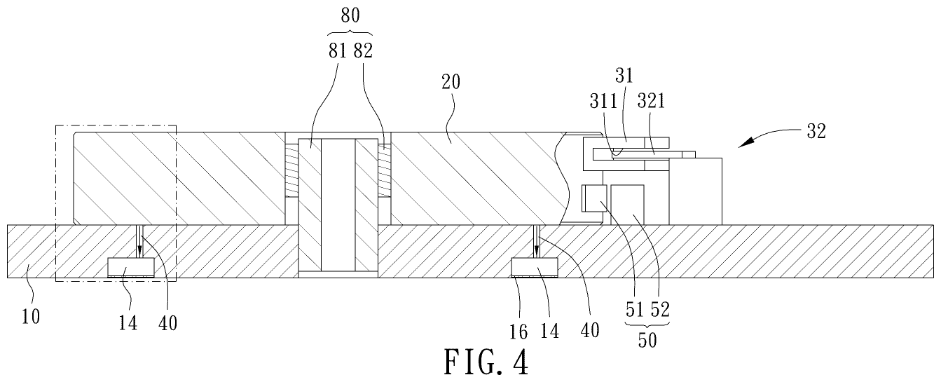

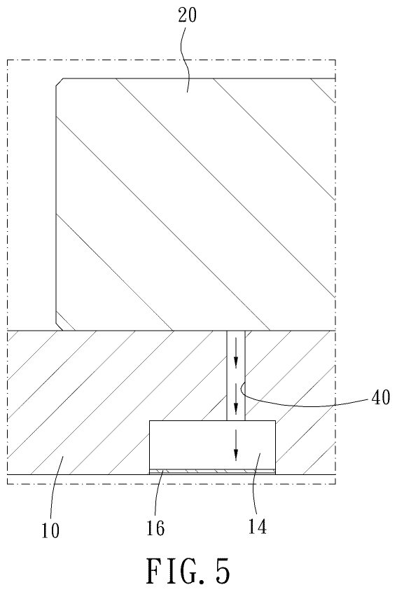

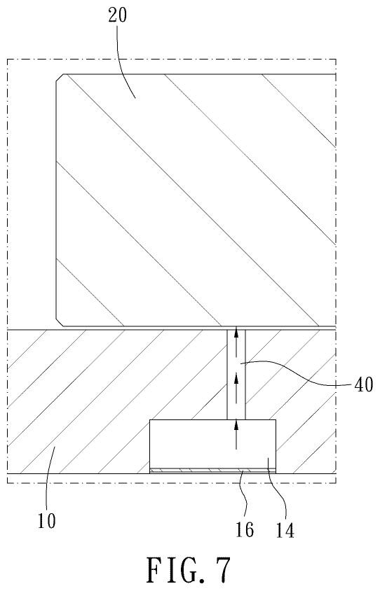

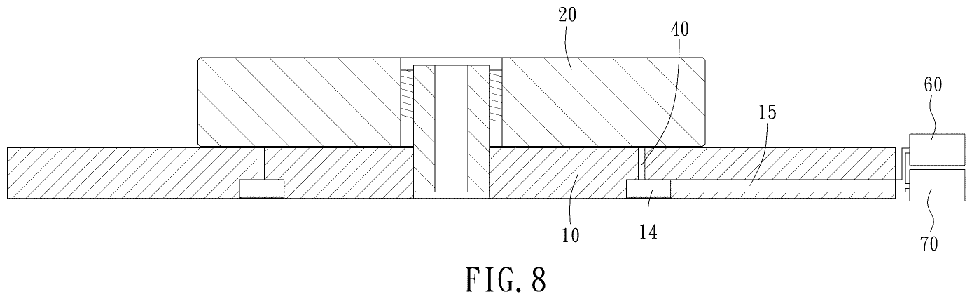

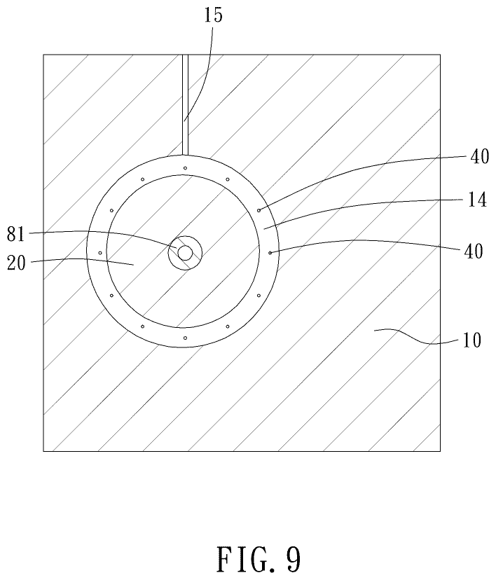

Please refer to FIGS. 1 to 9 for a first exemplary embodiment of the present invention. An alignment platform 1 of the present invention includes a base 10, a platform member 20, a drive device 30, at least one air passageway 40, and an optical measuring device 50.

The platform member 20 is movably disposed on the base 10. In this embodiment, the platform member 20 is rotatable relative to the base 10, but is not limited thereto. A carrier may be placed on the platform member 20, and a workpiece, such as a wafer but not limited thereto, may be placed on the carrier. The drive device 30 is configured to drive the platform member 20 to move relative to the base 10. The at least one air passageway 40 is disposed in one of the base 10 and the platform member 20 to eject air so as to support the platform member 20 above the base 10 in a non-contact manner (in a suspended manner). The optical measuring device 50 includes an optical scale 51 and a read head 52. One of the optical scale 51 and the read head 52 is disposed on the platform member 20, and the other of the optical scale 51 and the read head 52 is disposed on the base 10. The optical scale 51 and the read head 52 correspond to each other. In this embodiment, the optical scale 51 is disposed on an outer peripheral surface of the platform member 20, and the read head 52 is disposed on the base 10 so as to be advantageous to precise measurement.

The platform member 20 can be suspended above the base 10 to move (rotate) relative to the base 10, so that contact between the platform member 20 and the base 10 is reduced, thereby enabling smooth movement. The optical measuring device 50 is further used to precisely measure and calibrate a position of the platform member 20 so as to achieve an effect of high-accuracy alignment calibration.

The platform member 20 defines a central axis 2, and the platform member 20 is rotatable relative to the base 10 about the central axis 2. The at least one air passageway includes a plurality of the air passageways 40, and the plurality of air passageways 40 are arranged around the central axis 2 at intervals. Specifically, the base 10 and the platform member 20 are connected to each other by a shaft assembly 80. The shaft assembly 80 includes a shaft body 81 and a bearing 82. The shaft body 81 extends through the platform member 20, the bearing 82 is disposed between the platform member 20 and the shaft body 81, and the platform member 20 is rotatable about the shaft body 81 relative to the base 10. The central axis 2 passes through a center of the bearing 82. In this embodiment, the shaft body 81 extends through a first mounting hole of the base 10 and a second mounting hole of the platform member 20. Therefore, the platform member 20 can stably and smoothly rotate relative to the base 10 and is not prone to wobbling. Preferably, a radial distance from each of the plurality of air passageways 40 to the central axis 2 is greater than a circumferential spacing distance between two adjacent ones of the plurality of air passageways 40 so that air ejected from the air passageways 40 uniformly supports the platform member 20. As a result, a supporting force is good, stability in movement is improved, wobbling is reduced, and the platform member 20 can also be stably sucked.

Specifically, each of the air passageways 40 is connected to a blowing unit 60 and a suction unit 70. The blowing unit 60 is configured to supply air to each of the air passageways 40 for ejection of the air so as to drive the platform member 20 to remain spaced from the base 10 by air pressure. The suction unit 70 is configured to draw air through each of the air passageways 40 to generate a suction force to suck and position the platform member 20 on the base 10. Therefore, when it is desired to adjust a position of the platform member 20, the platform member 20 can be set to be in a suspended state to facilitate adjustment. When it is desired to position the platform member 20, the platform member 20 can be sucked so that the platform member 20 can be stably positioned on the base 10.

The drive device 30 includes a first magnetic unit 31 and a second magnetic unit 32. The first magnetic unit 31 is a magnet, and the second magnetic unit 32 is a coiled magnetic unit such as an electromagnet. One of the first magnetic unit 31 and the second magnetic unit 32 is mounted on the platform member 20, and the other of the first magnetic unit 31 and the second magnetic unit 32 is mounted on the base 10. In this embodiment, the first magnetic unit 31 is mounted on the platform member 20, and the second magnetic unit 32 is mounted on the base 10. The first magnetic unit 31 includes a guide groove 311 radially open, and the second magnetic unit 32 includes a guide member (sheet-shaped) 321 radially extending. The guide member 321 is radially inserted in the guide groove 311. The guide member 321 and the guide groove 311 are movable relative to each other, and the second magnetic unit 32 is configured to generate a magnetic field to drive the first magnetic unit 31 to drive the base 10 to rotate relative to the platform member 20. Preferably, an axial dimension of an annular groove 14 is greater than a thickness dimension of the guide member 321 so that the guide member 321 does not contact the first magnetic unit 31 and can smoothly move relative thereto. Accordingly, position can be calibrated with high accuracy, and, by utilizing a non-contact driving manner, friction between the first magnetic unit 31 and the second magnetic unit 32 can be reduced to thereby prolong service life. In other embodiments, the drive device 30 may be a linear motor or may be driven by a screw rod.

Specifically, the platform member 20 is disposed on the base 10 in an axial direction. The base 10 includes an annular recess 11. Specifically, the annular recess 11 is disposed on a top surface of the base 10, and the top surface faces the platform member 20. The annular recess 11 includes an annular bottom wall 12, an annular circumferential wall 13 and the annular groove 14. The annular bottom wall 12 and the annular circumferential wall 13 define the annular groove 14. The plurality of air passageways 40 are disposed on the annular bottom wall 12. Each of the air passageways 40 is a through hole, and the through hole extends through the base 10. The base 10 further includes a channel 15 extending through the base 10. The channel 15 is radially open toward the annular circumferential wall 13 and is in communication with the annular groove 14. Furthermore, the base 10 further includes a cover 16 which seals the annular groove 14. The cover 16 can seal the annular groove 14 so as to prevent air leakage when the platform member 20 is suspended by blowing air, and to prevent external air from flowing in when air within the annular groove 14 and between the platform member 20 and the base 10 is drawn. In addition, the annular recess 11 and the plurality of air passageways 40 are easy to process and manufacture.

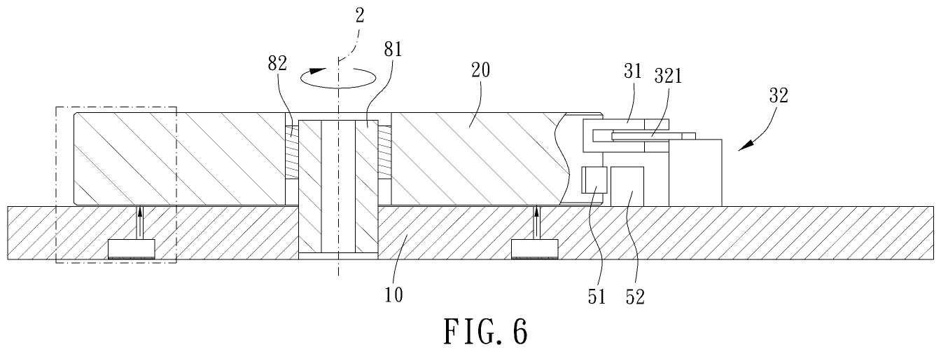

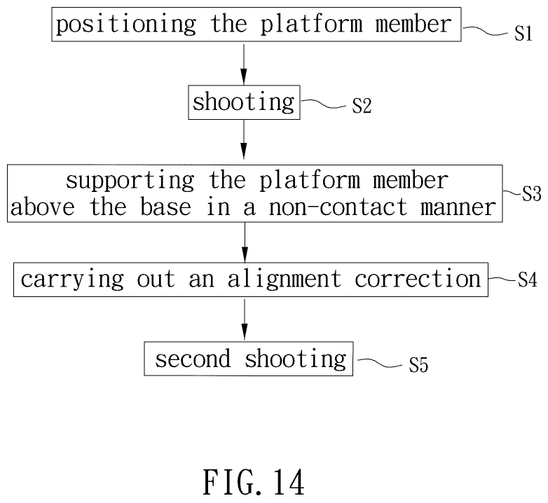

Please refer to FIG. 14 with FIGS. 1 to 9. The present invention further provides a calibration method carried out with the above-mentioned alignment platform 1, and the calibration method includes following steps. Step S1: positioning the platform member 20 by each of the at least one air passageway 40 sucking the platform member 20 to be on the base 10. Step S2: shooting a workpiece placed on the platform member 20 to obtain an imaging result. Step S3: supporting the platform member 20 above the base 10 in a non-contact manner by ejection of air from each of the at least one air passageway 40. Step S4: carrying out an alignment correction by driving the platform member 20 to rotate relative to the base 10 to perform position correction according to the imaging result and a measuring result of the optical measuring device 50 (see FIG. 6). Step S5: positioning the platform member 20 by each of the at least one air passageway 40 sucking the platform member 20 to be on the base 10, and shooting the workpiece placed on the platform member 20 again, so that a corrected position can be confirmed once again through secondary shooting. Therefore, by sucking the platform member 20 during shooting for positioning, precision of a shooting position can be ensured. After shooting is completed, the platform member 20 is suspended, and the optical measuring device 50 is used to perform measurement, thereby achieving precise alignment calibration. After calibration is completed, the platform member 20 is sucked again for positioning to perform shooting, thus achieving high-accuracy alignment calibration.

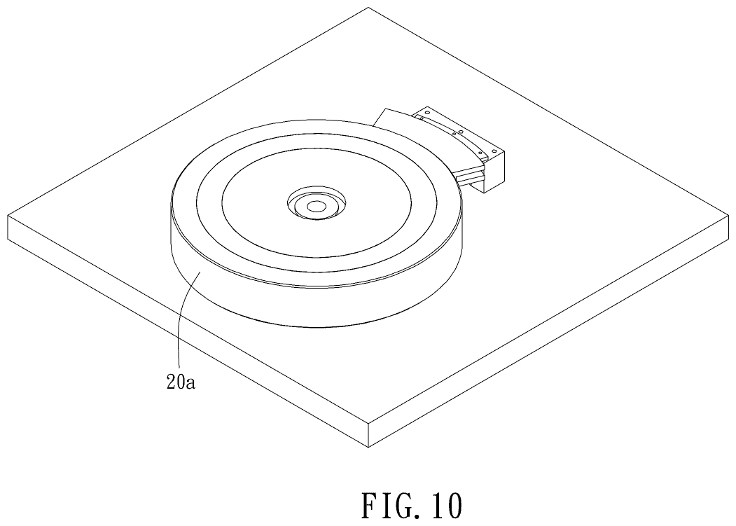

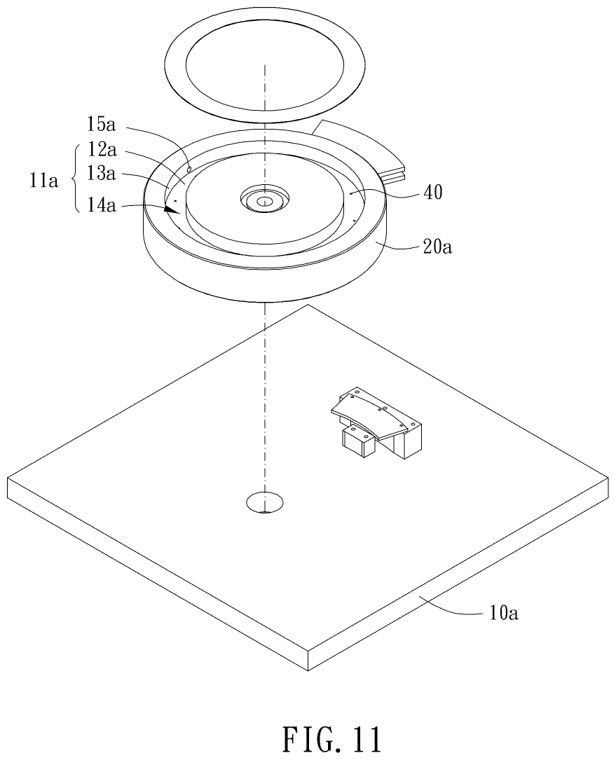

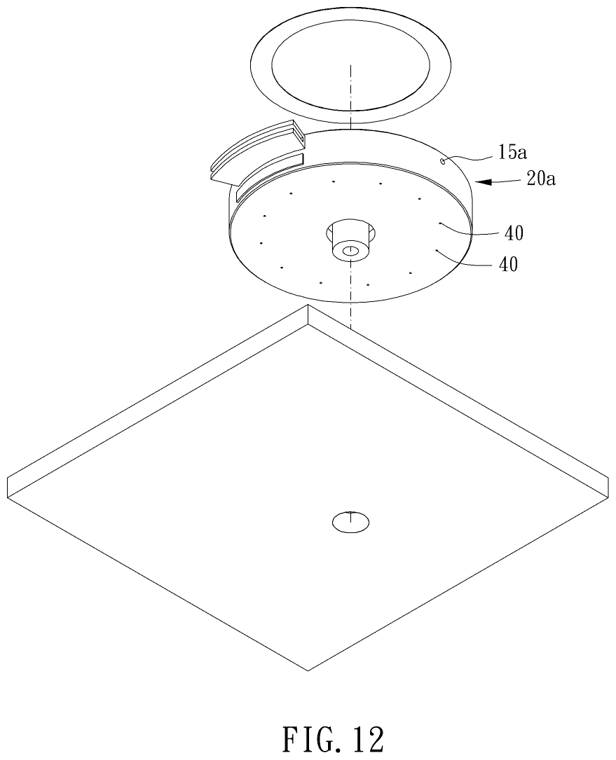

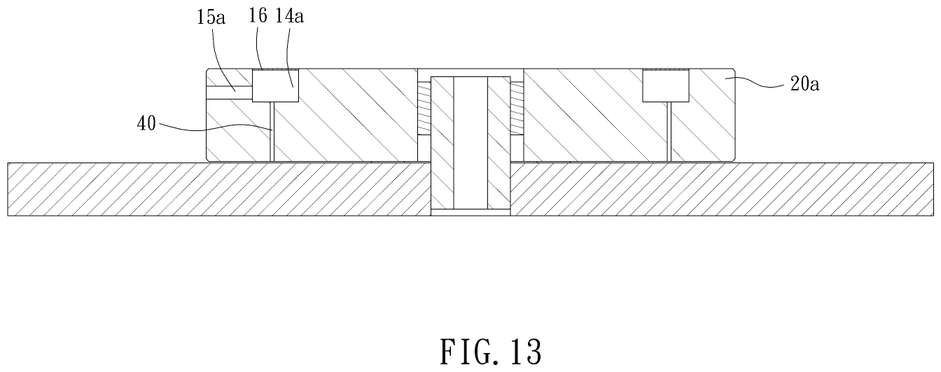

Please refer to FIG. 10 to FIG. 13, which show a second exemplary embodiment of the present invention. A platform member 20a has, on a side facing away from a base 10a, an annular recess 11a. The annular recess 11a includes an annular bottom wall 12a, an annular circumferential wall 13a and an annular groove 14a. The annular bottom wall 12a and the annular circumferential wall 13a define the annular groove 14a. The plurality of air passageways 40 are disposed on the annular bottom wall 12a. Each of the air passageways 40 is a through hole, and the through hole extends through the platform member 20a. The base 10a further includes a channel 15a extending through the base 10a. The channel 15a is radially open toward the annular circumferential wall 13a and is in communication with the annular groove 14a. The platform member 20a can be independently replaced and maintained. For example, the platform member 20a can be removed for cleaning and maintaining each of the air passageways 40 and the annular groove 14a. In addition, it provides high stability in suspension and suction positioning.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An alignment platform including:
a base;
a platform member movably disposed on the base;
a drive device configured to drive the platform member to move relative to the base;
at least one air passageway, the at least one air passageway being disposed in one of the base and the platform member to eject air so as to support the platform member above the base in a non-contact manner; and
an optical measuring device including an optical scale and a read head, one of the optical scale and the read head being disposed on the platform member, the other of the optical scale and the read head being disposed on the base, the optical scale and the read head corresponding to each other.

2. The alignment platform of claim 1, wherein the platform member defines a central axis, the platform member is rotatable relative to the base about the central axis, the at least one air passageway includes a plurality of air passageways, and the plurality of air passageways are arranged around the central axis at intervals.

3. The alignment platform of claim 1, wherein each of the at least one air passageway is connected to a blowing unit and a suction unit, the blowing unit is configured to supply air to each of the at least one air passageway for ejection of the air so as to drive the platform member to remain spaced from the base by air pressure, and the suction unit is connected to draw air through each of the at least one air passageway to generate a suction force to position the platform member on the base.

4. The alignment platform of claim 1, wherein the base and the platform member are connected to each other by a shaft assembly, the shaft assembly includes a shaft body and a bearing, the shaft body extends through the platform member, the bearing is disposed between the platform member and the shaft body, and the platform member is rotatable about the shaft body relative to the base.

5. The alignment platform of claim 1, wherein the optical scale is disposed on an outer peripheral surface of the platform member, and the read head is disposed on the base.

6. The alignment platform of claim 1, wherein the drive device includes a first magnetic unit and a second magnetic unit, one of the first magnetic unit and the second magnetic unit is disposed on the platform member, the other of the first magnetic unit and the second magnetic unit is disposed on the base, the first magnetic unit includes a guide groove radially open, the second magnetic unit includes a guide member radially extending and radially inserted in the guide groove, the guide member and the guide groove are movable relative to each other, and the second magnetic unit is configured to generate a magnetic field to drive the first magnetic unit to drive the base to rotate relative to the platform member.

7. The alignment platform of claim 2, wherein the platform member is disposed on the base, the base includes an annular recess, the annular recess includes an annular bottom wall, an annular circumferential wall and an annular groove, the annular bottom wall and the annular circumferential wall define the annular groove, the plurality of air passageways are disposed on the annular bottom wall, and the base further includes a channel radially open toward the annular circumferential wall and in communication with the annular groove.

8. The alignment platform of claim 2, wherein a side of the platform member facing away from the base includes an annular recess, the annular recess includes an annular bottom wall, an annular circumferential wall and an annular groove, the annular bottom wall and the annular circumferential wall define the annular groove, the plurality of air passageways are disposed on the annular bottom wall, and the base further includes a channel radially open toward the annular circumferential wall and in communication with the annular groove.

9. The alignment platform of claim 7, wherein each of the plurality of air passageways is connected to a blowing unit and a suction unit, the blowing unit is configured to supply air to each of the at least one air passageway for ejection of the air so as to drive the platform member to remain spaced from the base by air pressure, and the suction unit is connected to draw air through each of the at least one air passageway to generate a suction force to position the platform member on the base; the base and the platform member are connected to each other by a shaft assembly, the shaft assembly includes a shaft body and a bearing, the shaft body extends through the platform member, the bearing is disposed between the platform member and the shaft body, and the platform member is rotatable about the shaft body relative to the base; the optical scale is disposed on an outer peripheral surface of the platform member, and the read head is disposed on the base; the base further includes a cover which seals the annular groove; a radial distance from each of the plurality of air passageways to the central axis is greater than a circumferential spacing distance between two adjacent ones of the plurality of air passageways; the drive device includes a first magnetic unit and a second magnetic unit, one of the first magnetic unit and the second magnetic unit is disposed on the platform member, the other of the first magnetic unit and the second magnetic unit is disposed on the base, the first magnetic unit includes a guide groove radially open, the second magnetic unit includes a guide member radially extending and radially inserted in the guide groove, the guide member and the guide groove are movable relative to each other, and the second magnetic unit is configured to generate a magnetic field to drive the first magnetic unit to drive the base to rotate relative to the platform member; an axial dimension of the annular groove is greater than a thickness dimension of the guide member.

10. A calibration method carried out with the alignment platform of claim 1,
including steps of:
positioning the platform member by each of the at least one air passageway sucking the platform member to be on the base;
shooting a workpiece placed on the platform member to obtain an imaging result;
supporting the platform member above the base in a non-contact manner by ejection of air from each of the at least one air passageway;
carrying out an alignment correction by driving the platform member to rotate relative to the base to perform position correction according to the imaging result and a measuring result of the optical measuring device; and
positioning the platform member by each of the at least one air passageway sucking the platform member to be on the base, and shooting the workpiece placed on the platform member again.
